(19) United States
(12) Patent Application Publication
(10) Pub. No.: US 2026/0046563 A1
(43) Pub. Date: Feb. 12, 2026

(54) ACOUSTIC OUTPUT DEVICES

(71) Applicant: SHENZHEN SHOKZ CO., LTD., Shenzhen (CN)

(72) Inventors: Jianing LIANG, Shenzhen (CN); Chenyang WU, Shenzhen (CN); Xin QI, Shenzhen (CN); Jinbo ZHENG, Shenzhen (CN); Fengyun LIAO, Shenzhen (CN)

(73) Assignee: SHENZHEN SHOKZ CO., LTD., Shenzhen (CN)

(21) Appl. No.: 19/359,646

(22) Filed: Oct. 15, 2025

Related U.S. Application Data
(63) Continuation of application No. PCT/CN2023/136093, filed on Dec. 4, 2023.

(51) Int. Cl. H04R 3/12; H04R 1/02; H04R 1/32; H04R 3/04

(52) U.S. Cl. CPC H04R 3/12; H04R 1/025; H04R 1/323; H04R 3/04

(57) ABSTRACT

The present disclosure relates to an acoustic output device including: a housing; a first speaker disposed in the housing and acoustically coupled to two holes disposed in the housing, respectively, to output a first sound wave and a second sound wave with a phase differences; a second speaker disposed in the housing and acoustically coupled to a hole provided on the housing to output a third sound wave; a processing circuit configured to provide a first electrical signal to the first speaker and provide a second electrical signal to the second speaker. There is an amplitude difference and/or a phase difference between the first electrical signal and the second electrical signal in a target frequency range to make a far-field radiated sound of the acoustic output device exhibit at least one directional sound pressure distribution.

### CROSS-REFERENCE TO RELATED APPLICATIONS

This application is a Continuation of International Patent Application No. PCT/CN2023/136093, filed on Dec. 4, 2023, the entire contents of which are incorporated herein by reference.

### TECHNICAL FIELD

The present disclosure relates to the field of acoustics, and in particular to an acoustic output device.

### BACKGROUND

To solve the problem of sound leakage of an acoustic output device, two sound sources are usually utilized to emit two groups of sounds with opposite phases. A sound path difference between the two groups of sounds with opposite phases arriving at a point in a far field is essentially negligible, so the two groups of sounds may cancel each other to reduce a far-field sound leakage. Although this manner can reduce the sound leakage to a certain extent, there are still some limitations.

### SUMMARY

Embodiments of the present disclosure provide an acoustic output device including: a housing, a first speaker disposed in the housing, a second speaker disposed in the housing, and a processing circuit. The first speaker includes a first diaphragm, in the housing, a front side and a rear side of the first diaphragm are respectively disposed with a first front cavity and a first rear cavity, and the first front cavity and the first rear cavity are acoustically coupled to two holes disposed on the housing, respectively to output a first sound wave and a second sound wave with a phase difference. The second speaker includes a second diaphragm, in the housing, a front side and a rear side of the second diaphragm are disposed with a second front cavity and a second rear cavity, and only one of the second front cavity and the second rear cavity is acoustically coupled to a hole disposed on the housing to output a third sound wave. The processing circuit is configured to provide a first electrical signal to the first speaker and provide a second electrical signal to the second speaker. In a target frequency range, there is an amplitude difference and/or a phase difference between the first electrical signal and the second electrical signal to make a far-field radiated sound from the acoustic output device exhibit at least one directional sound pressure distribution.

Alternative embodiments of the present disclosure further provide an acoustic output device including: a housing; a first speaker disposed in the housing, a second speaker disposed in the housing, and a processing circuit. The first speaker includes a first diaphragm, in the housing, a front side and a rear side of the first diaphragm are respectively disposed with a first front cavity and a first rear cavity, and the first front cavity and the first rear cavity are acoustically coupled to two holes disposed in the housing, respectively, to output a first sound wave and a second sound wave with a phase difference. The second speaker includes a second diaphragm, in the housing, a front side and a rear side of the second diaphragm are respectively disposed with a second front cavity and a second rear cavity, and only one of the second front cavity and the second rear cavity is acoustically coupled to a hole disposed on the housing to output a third sound wave. The processing circuit is configured to provide a first electrical signal to the first speaker and provide a second electrical signal to the second speaker. The processing circuit is capable of obtaining a plurality of filter function groups, each of the plurality of filter function groups includes a first filter function and a second filter function corresponding to the first electrical signal and the second electrical signal, respectively. The first electrical signal and the second electrical signal are modulated in response to the first filter function and the second filter function, respectively. Different filter function groups in the plurality of filter function groups provide different sound pressure distributions for the acoustic output device at the same frequency.

Alternative embodiments of the present disclosure further provide an acoustic output device including: a housing, a first speaker disposed in the housing, a second speaker disposed in the housing, and a processing circuit. The first speaker outputs sound waves through at least one hole on the housing, and the first speaker has a first response function in a far field. The second speaker outputs sound waves through the at least one hole on the housing, and the second speaker has a second response function in the far field. The processing circuit is configured to provide a first electrical signal for the first speaker and provide a second electrical signal for the second speaker, and the processing circuit constructs at least one constraint function group based on the first response function and the second response function. Each constraint function group in the at least one constraint function group is used to produce a first filter function corresponding to the first electrical signal and a second filter function corresponding to the second electrical signal, the first electrical signal and the second electrical signal are modulated by the first filter function and the second filter function, respectively, and the each constraint function group provides a specific sound pressure distribution for the acoustic output device.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating relative positions of an acoustic output device and a user's ear according to some embodiments of the present disclosure;

FIG. 2 is a schematic diagram illustrating a sound pressure level distribution of the acoustic output device shown in FIG. 1;

FIG. 3 is a block diagram illustrating an electrical signal adjustment according to some embodiments of the present disclosure;

FIG. 4 is a graph illustrating sound pressure level curves obtained from testing according to some embodiments of the present disclosure;

FIG. 5 is a graph illustrating a time domain and a frequency domain of filter functions ω₁ and ω₂ according to some embodiments of the present disclosure;

FIG. 6 is a schematic diagram illustrating a sound pressure distribution obtained from testing according to some embodiments of the present disclosure;

FIG. 7-FIG. 10 are schematic diagrams illustrating acoustic output devices with different structures according to some embodiments of the present disclosure;

FIG. 11 is a schematic diagram illustrating a structure of an acoustic output device according to some other embodiments of the present disclosure; and

FIG. 12 is a schematic diagram illustrating a directivity according to some embodiments of the present disclosure.

### DETAILED DESCRIPTION

The more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for those skilled in the art to apply the present disclosure to other similar scenarios in accordance with these drawings without creative labor. Unless obviously obtained from the context or the context illustrates otherwise, the same numeral in the drawings refers to the same structure or operation.

It should be understood that, as used herein, the terms “system,” “device,” “unit,” and/or “module” as used herein is a way to distinguish between different components, elements, parts, sections, or assemblies at different levels. However, the words may be replaced by other expressions if other words accomplish the same purpose.

As shown in the specification and the claims, unless the context clearly suggests an exception, the words “a,” “an,” “one,” and/or “the” do not refer specifically to the singular, but may also include the plural. In general, the terms “including” and “comprising” only suggest the inclusion of explicitly identified operations and elements that do not constitute an exclusive list, and the method or device may also include other operations or elements.

Flowcharts are used in the present disclosure to illustrate operations performed by a system in accordance with embodiments of the present disclosure. It should be appreciated that the preceding or following operations are not necessarily performed in an exact sequence. Instead, operations may be processed in reverse order or simultaneously. Also, it is possible to add other operations to these processes or remove an operation or operations from these processes.

In some embodiments, to solve the problem of sound leakage of the acoustic output device, two groups of sounds with opposite phases may be emitted utilizing two sound sources with opposite phases. In the far field, a sound path difference between the two sound sources with opposite phases arriving at a point in the far field is essentially negligible, so the two groups of sounds cancel each other out to reduce a far-field sound leakage.

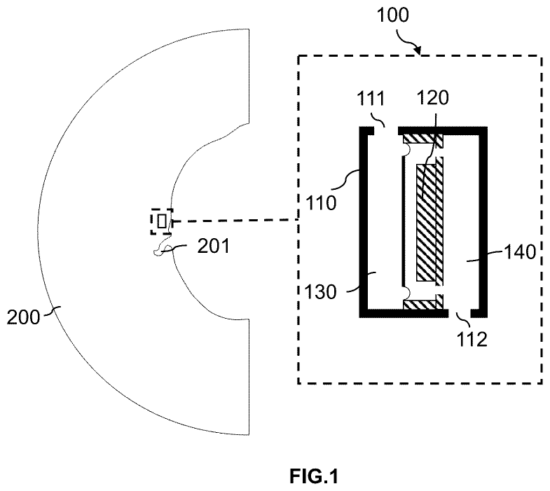

FIG. 1 is a schematic diagram illustrating relative positions of an acoustic output device and a user's ear according to some embodiments of the present disclosure. As shown in FIG. 1, the acoustic output device 100 may include a housing 110 and a speaker 120. The speaker 120 may be provided in a cavity formed by the housing 110, and the speaker 120 includes a diaphragm. In the cavity of the housing 110, a front cavity 130 and a rear cavity 140 are respectively disposed on a front side and a rear side of the diaphragm for radiating sound. The housing 110 is disposed with a first hole 111 and a second hole 112. The front cavity 130 may be acoustically coupled to the first hole 111, and the rear cavity 140 may be acoustically coupled to the second hole 112. The speaker 120 generates sound waves in response to an electrical signal, and when the speaker 120 outputs the sound waves, the sound waves on the front side of the diaphragm (or referred to as first sound wave) may be emitted from the first hole 111 through the front cavity 130, and the sound waves on the rear side of the diaphragm (or referred to as second sound wave) may be emitted from the second hole 112 through the rear cavity 140. At this time, the first hole 111 and the second hole 112 may be regarded as a group of dual sound sources capable of emitting two groups of sounds with the same amplitude and opposite phases. For ease of understanding, in some embodiments of the present disclosure, the front side of the diaphragm refers to a side of the diaphragm away from a magnetic circuit assembly, and the rear side of the diaphragm refers to a side of the diaphragm facing the magnetic circuit assembly. In some scenarios, the front side and the rear side of the diaphragm may be interchangeable; that is, the side of the diaphragm away from the magnetic circuit assembly may be taken as the rear side, and the side of the magnetic circuit assembly away from the diaphragm may be taken as the front side.

In some embodiments, as shown in FIG. 1, when the user wears or uses the acoustic output device 100, the acoustic output device 100 is placed near an auricle 200 of the user, and the first hole 111 faces an ear canal opening 201 of the user. Thereby, the sound emitted from the first hole 111 may propagate toward the ear canal opening 201 of the user. The second hole 112 may be located away from the ear canal opening 201 relative to the first hole 111, and a distance between the first hole 111 and the ear canal opening is less than a distance between the second hole 112 and the ear canal opening.

In some embodiments, when the speaker 120 vibrates, the front and rear sides of the speaker 120 each act as a sound wave generating structure to generate the sound waves with the same amplitude and opposite phases. The sound waves with the same amplitude and opposite phases may be radiated outwardly through the first hole 111 and the second hole 112, respectively, to form the dual sound sources. The dual sound sources may undergo an interference phase cancellation at a spatial point (e.g., the far field), which effectively reduces the sound leakage in the far field of the headphone 100.

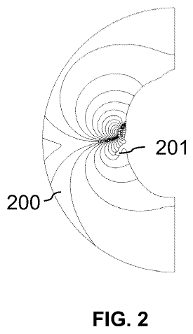

FIG. 2 is a schematic diagram illustrating a sound pressure level distribution of the acoustic output device shown in FIG. 1. As shown in FIG. 2, a sound pressure distribution of the acoustic output device 100 exhibits an obvious directivity, and a sound leakage reduction effect of the acoustic output device 100 in certain directions is significant. Specifically, in middle and low frequency bands, dual sound sources formed by the first hole 111 and the second hole 112 of the acoustic output device 100 output sound waves with opposite phases (i.e., the first sound wave and the second sound wave), and a sound field forms a distribution mode of two flap structures in space. A sound pressure level is relatively great along two opposite directions of a line connecting the dual sound sources and is relatively small along a direction perpendicular to the line connecting the dual sound sources, i.e., the sound leakage reduction effect is relatively good. For the two flap structures formed in the sound field, one of the flap structures is far away from the user's ear and forms a relatively great sound leakage, which increases the sound leakage performance of the acoustic output device.

When the dual sound sources have opposite phases, a sound field distribution in the far field of the acoustic output device has a clear directivity. In this situation, the acoustic output device produces a relatively great far-field sound leakage in the direction of a line connecting the dual sound sources, which brings a poor user experience for applications in specific scenarios (e.g., scenarios that require a high sound leakage reduction in the direction of the line connecting the dual sound sources). In some embodiments, to provide the acoustic output device with a sound leakage reduction effect that is flexible and satisfies the needs of a specific scenario, an amplitude and/or a phase (e.g., the amplitude, the phase, or the amplitude and the phase) of the first sound wave and the second sound wave are adjusted such that a far-field sound pressure of the acoustic output device in a specific direction or a specific direction range is within an expected range, when the dual sound sources are employed. In some alternative embodiments, more than two sound sources are used, and by respectively controlling the amplitude and/or the phase of the sound waves emitted from each of the sound sources, the far-field sound pressure of the acoustic output device in the specific direction or the specific direction range is in an expected range.

In some embodiments, to facilitate an adjustment of the amplitude and/or the phase of the sound waves emitted from each sound source, the acoustic output device includes a plurality of speakers that are each driven by a separate electrical signal. By respectively modulating the electrical signals driving the plurality of speakers, for example, by respectively applying different filter functions to the electrical signals corresponding to the plurality of speakers, the sound waves generated by the sound sources (i.e., each hole on the acoustic output device coupled to the speakers) present a magnitude and/or phase relationship that satisfies a condition, thereby flexibly adjusting the distribution of the sound pressure formed by the acoustic output device in the far field, so as to ensure the sound leakage reduction effect of the acoustic output device in the specific direction or within the specific direction range to satisfy the different requirements of the users in different application scenarios. For illustration only, the following contents exemplarily illustrate a method for regulating the sound pressure distribution and a corresponding structure, etc., taking the acoustic output device including two speakers as an example. It is understood that, when the acoustic output device includes more speakers, the method for regulating the sound pressure distribution and the corresponding structure, etc., may be obtained by analogy the contents disclosed in some embodiments of the present disclosure without creative work.

In some embodiments, the acoustic output device includes a first speaker, a second speaker, and a processing circuit. The first speaker and the second speaker are disposed within the housing. The first speaker includes a first diaphragm, the processing circuit provides a first electrical signal to the first speaker, and the first diaphragm generates sound waves in response to the first electrical signal. The second speaker includes a second diaphragm, the processing circuit provides a second electrical signal to the second speaker, and the second diaphragm generates sound waves in response to the second electrical signal.

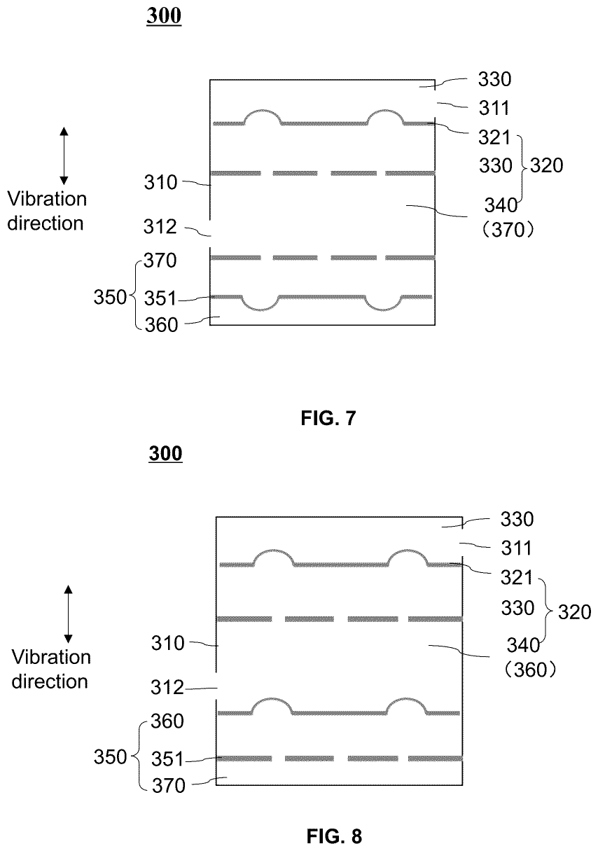

The sound waves generated by the first diaphragm and the second diaphragm are radiated outward through one or more holes on the housing, respectively. For example, the first speaker is acoustically coupled to two holes (e.g., the first hole and the second hole) on the housing, respectively, to output the first sound wave and the second sound wave with a phase difference. The second speaker is acoustically coupled to two holes (e.g., the third hole and the fourth hole) on the housing, respectively, to output a third sound wave and a fourth sound wave with a phase difference. At this time, both the first speaker and the second speaker form the dual sound sources, and the first sound wave, the second sound wave, the third sound wave, and the fourth sound wave may be superimposed in the far field. As another example, the first speaker is acoustically coupled to each of the two holes (e.g., the first hole and the second hole) on the housing, respectively, to output the first sound wave and the second sound wave, and the second speaker is acoustically coupled to only one hole (e.g., the third hole) disposed on the housing to output the third sound wave. At this time, the first speaker forms the dual sound sources, the second speaker forms a single sound source, and the first sound wave, the second sound wave, and the third sound wave may be superimposed in the far field. As another example, the first speaker is acoustically coupled to only one hole (e.g., the first hole) on the housing to output the first sound wave. The second speaker is acoustically coupled to only one hole (e.g., the third hole) on the housing to output the third sound wave. At this time, the first speaker and the second speaker both form a single sound source, and the first sound wave and the third sound wave may be superimposed in the far field. Related descriptions of the specific structure of the acoustic output device may be found in other parts of the present disclosure. For example, FIGS. 7-11 and the corresponding contents illustrate the specific structure of the acoustic output device taking the first speaker forming the dual sound sources and the second speaker forming the single sound source as an example.

In some embodiments, by modulating the amplitude and/or the phase of the first electrical signal, the second electrical signal and the first electrical signal have a certain difference in the amplitude and/or the phase in a target frequency range. When the sound wave output by the second speaker is superimposed with the sound wave output by the first speaker in the far field, the far-field radiation of the acoustic output device can present a specific sound pressure distribution. For example, the far-field sound pressure distribution of the acoustic output device has directivity, which is manifested as the far-field sound pressure with a relatively small intensity in a specific direction or a specific direction range, which in turn reduces the far-field sound leakage of the acoustic output device in the specific direction or the specific direction range.

The target frequency range refers to a frequency range in which the sound pressure distribution of a specific directivity may be realized. In some embodiments, by modulating the amplitudes and/or the phases of the first electrical signal and the second electrical signal in different frequency ranges in different ways, the far-field radiation of the acoustic output device at different frequency ranges may respectively present different sound pressure distributions. In some embodiments, the target frequency range includes frequency bands to which the human ear is more sensitive, including a range of 200 Hz-8000 Hz. In the more sensitive frequency band of the human ear, by constructing the sound pressure distribution of the acoustic output device in the far field, the far-field sound leakage in a direction where other people are more likely to appear is reduced, which is conducive to reducing the interference to other people and protecting the privacy of a user's listening.

In some embodiments, the processing circuit of the acoustic output device includes a filter. The filter may be utilized to adjust the amplitude and/or the phase of the electrical signal to output an expected first electrical signal and an expected second electrical signal to the first speaker and the second speaker, respectively. In some embodiments, the filter processes the signals based on a filter function to adjust the amplitude and/or the phase of the first electrical signal and the second electrical signal in the target frequency range. In some embodiments, the filter is an infinite impulse response (IIR) filter. The IIR filter is less computationally intensive and more real-time. In some embodiments, the filter is a finite impulse response (FIR) filter. The FIR filter has good stability and is phase controllable, which allows synchronized input signals to be output synchronously while performing the amplitude selection, thereby avoiding signal distortion.

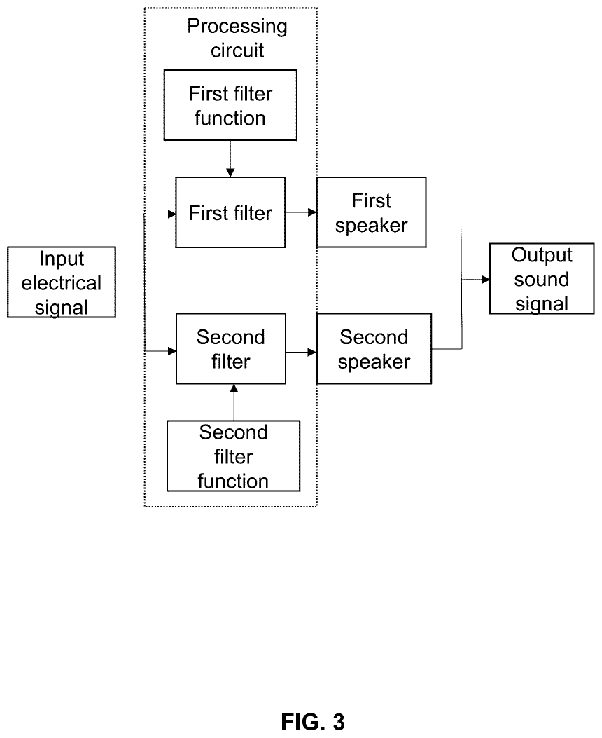

FIG. 3 is a block diagram illustrating an electrical signal adjustment according to some embodiments of the present disclosure.

A processing circuit can provide one or more filter function groups, each filter function group includes a first filter function ω₁ corresponding to a first electrical signal and a second filter function ω₂ corresponding to a second electrical signal. The first electrical signal is modulated in response to the first filter function ω₁, and the second electrical signal is modulated in response to the second filter function ω₂. As shown in FIG. 3, the filters of the processing circuit may include a first filter and a second filter. The first filter and the second filter accept the first filter function ω₁ and the second filter function ω₂ in a plurality of filter function groups, and filters the first electrical signal and the second electrical signal, thereby controlling sound signals output by the first speaker and the second speaker.

In some embodiments, the first electrical signal and the second electrical signal modulated by different filter function groups have different amplitudes and/or phases, thereby affecting the acoustic outputs of the first speaker and the second speaker, thereby providing an acoustic output device with different sound pressure distributions.

In some embodiments, the first filter function ω₁ and the second filter function ω₂ are determined based on a constraint function. The constraint function refers to a functional expression that constrains the sound pressure distribution of an acoustic sound generation device (including the first speaker and the second speaker) in a far field. The constraint function is related to the output capability of each speaker in the acoustic output device in the far field. The output capability of the speaker in the far field may be expressed as a response function of the speaker in the far field, and the response function may represent a sound pressure level of the speaker in the far field.

In some embodiments, the response function of the speaker in the far field is obtained through measurement or simulation, etc. Merely by way of example, a circular boundary centered on the acoustic output device (e.g., taking a centroid of the plurality of sound sources as the center of the circle) and having a sufficiently great radius is approximated as the far field of the acoustic output device. Microphones are set to collect microphone responses at various positions on the circular boundary. For example, a microphone response IR corresponding to an excitation of the speaker is collected at an x° interval on the circular boundary. In some embodiments, the position of the microphone is considered as the far field position of the acoustic output device when the radius is great enough. At this time, a distance between the microphone and the acoustic output device is greater than a preset distance threshold, e.g., greater than 25 cm. As the sound waves at different frequencies have different wavelengths, for shorter wavelengths, a distance between the far field position of the acoustic output device and the acoustic output device may be smaller. In some embodiments, the far field position of the acoustic output device is a position at a distance greater than 5.5 cm from the acoustic output device when the excitation signal is in a frequency range of 1000 Hz-4000 Hz.

In some embodiments, the smaller the value of x°, the more accurate the sound pressure distribution diagram drawn by simulation. In some embodiments, x° is in a range of 5°-10° to reduce the burden of the simulation. In some embodiments, a test signal that excites the speaker is a sweep signal, and a frequency range of the sweep signal is 200 Hz-8000 Hz to test the sound pressure distribution of the speaker in the frequency range of 200 Hz-8000 Hz. In some embodiments, the sweep signal refers to a signal that gradually varies from 200 Hz to 8000 Hz. The sweep signal only includes the signal with a single frequency at any given moment, and the sweep signal simulates a simple signal input. It is appreciated that the manner of obtaining the response function of the speaker exemplified herein is not the only manner of obtaining the response function of the speaker, and that those skilled in the art may, based on the purpose, make appropriate adjustments or changes.

In some embodiments, to minimize the far-field sound pressure level of the acoustic output device in a specific direction to minimize the far-field sound leakage of the acoustic output device in the specific direction, the response functions of each speaker in the specific direction are combined to construct the constraint function representing the sound pressure level of the acoustic output device in the specific direction. For ease of description, the response function of the speaker in a β° direction is denoted as IR_{β°}Minimizing the constraint function allows the sound pressure of the acoustic output device to have a relatively small intensity in the β° direction. Specifically, the constraint function consists of the response function and the filter function w corresponding to each speaker. When minimizing the constraint function, the filter function w corresponding to the speaker when the acoustic output device exhibits directivity in the β° direction may be obtained. That is, when the electrical signal is modulated by the aforementioned filter function w and then excites the speaker, the sound pressure distribution of the acoustic output device may have the directivity in the β° direction.

Merely by way of example, a first response function of the first speaker in the β° direction is denoted as IR1_{β°} and a second response function of the second speaker in the β° direction is denoted as IR2_{β°}. In some embodiments, to adjust the sound pressure distribution radiated outwardly by the first speaker and the second speaker simultaneously, the constraint function ∥ω₁*IR1_{β°}+ω₂*IR2_{β°}∥(also referred to as a first constraint function) is formed by combining a sound pressure expression ∥ω₁*IR1_{β°}∥modulated by the first filter function ω₁ corresponding to the first speaker and a sound pressure expression ∥ω₂*IR2_{β°}∥modulated by the second filter function ω₂ corresponding to the second speaker. The first constraint function may indicate a magnitude of the sound pressure level output by the acoustic output device in the β° direction. When minimizing the first constraint function, the first filter function ω₁ and the second filter function ω₂ when the acoustic output device exhibits a relatively small sound pressure level in the β° direction.

In some embodiments, by enabling the first filter to filter the first electrical signal based on the first filter function ω₁, enabling the second filter to filter the second electrical signal based on the second filter function ω₂, and making the first electrical signal and the second electrical signal generated after the filtering to excite the first speaker and the second speaker, respectively, the acoustic output device has the directivity in the β° direction, i.e., the sound pressure in the β° direction has a relatively small intensity. For example, taking the dual sound sources as an example, to realize the directivity of the acoustic output device in the direction of the line connecting the dual sound sources (e.g., the 180° direction described in FIGS. 7-11 of the present disclosure, i.e., the direction from the first hole 311 to the second hole 312 (also referred to as the second direction)), the response function of the first speaker in the 180° direction, IR1₁₈₀°, and the response function of the second speaker in the 180° direction, IR2₁₈₀°, are respectively substituted into the first constraint function to obtain the first constraint function ∥ω₁*IR1_{180°}+ω₂*IR2_{180° ∥.}

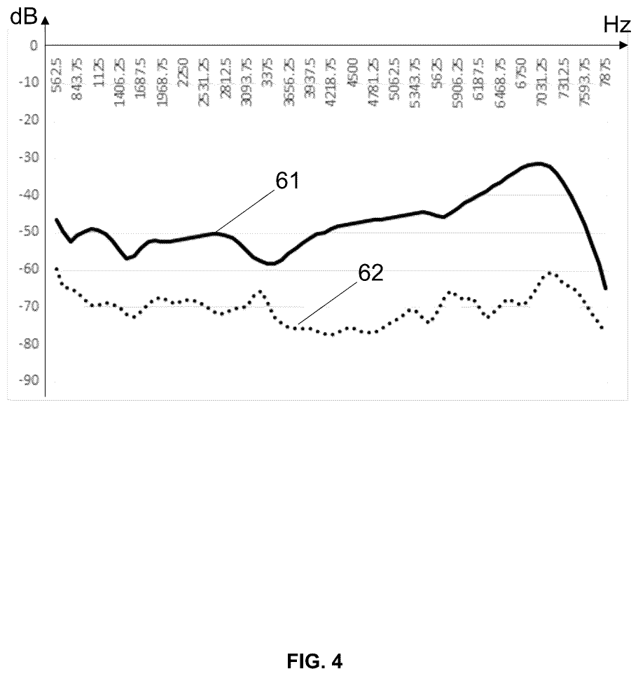

In some embodiments, the first filter function w, and the second filter function ω₂ are obtained based on ∥ω₁*IR1_{180°+ω2}*IR2₁₈₀° ∥, and the first electrical signal and the second electrical signal processed based on the first filter function ω₁ are used to excite the first speaker and the second speaker at the same time, the sound pressure level curve obtained from the test is shown in FIG. 4. FIG. 4 is a graph illustrating sound pressure level curves obtained from testing according to some embodiments of the present disclosure. As shown in FIG. 4, a horizontal coordinate represents a frequency in Hz, and a vertical coordinate represents a sound pressure level in dB. A curve 61 is the sound pressure level curve of the acoustic output device in an opposite direction of the 180° direction, i.e., in a 0° direction (i.e., the first direction from the second hole 312 to the first hole 311, as described in related contents of FIGS. 7-11 of the present disclosure) under an excitation signal of 200 Hz to 8000 Hz, and a curve 62 is the sound pressure level curve of the acoustic output device in the 180° direction under the excitation signal of 200 Hz to 8000 Hz. It may be seen from FIG. 4 that, under the excitations of the first electrical signal and the second electrical signal modulated by the first filter function ω₁ and the second filter function ω₂ obtained based on ∥ω₁*IR1₁₈₀₀₊₀₂*IR2₁₈₀° ∥, the difference of the sound pressure levels between the 0° direction and the 180° direction is in a range of 12 dB-25 dB, the far-field sound pressure level in the 180° direction is effectively reduced, and the 180° direction exhibits good directivity and has an effective sound leakage reduction effect. The differences in the sound pressure levels under the excitation of electric signals at different frequencies are different, that is, the sound leakage reduction effects at different frequencies are different. Thus, the filter functions ω₁ and ω₂ may provide a specific sound pressure distribution for the acoustic output device to achieve the directivity of the acoustic output device in a specific direction.

In some embodiments, the acoustic output device can have a relatively small far-field sound pressure, i.e., a relatively small average sound pressure level over a specific direction range, by constructing and minimizing a specific constraint function. The specific direction range refers to a direction range between one angular direction and another, or a direction range in the vicinity of an angular direction, and the direction range refers directly to all directions within a sector region. The direction range may be understood as a region range whose angle to a direction is less than a certain degree. Merely by way of example, for ease of description, the direction in the acoustic output device illustrated in FIGS. 7-11 is taken as an example, i.e., the direction from the first hole 311 to the second hole 312 is taken as the 180° direction (also referred to as the second direction), and the direction from the second hole 312 to the first hole 311 is taken as the 0° direction (also referred to as the first direction). At this time, the specific direction range is 135°-225°, which refers to all directions within a sector region between the 135° direction and the 225° direction, or all directions within a sector region formed by two angular directions with an angle less than 45° with the 180° direction.

Merely by way of example, to realize the directivities of the first speaker and the second speaker in a direction range of α°-β°, the sound pressure expressions ∥ω₁*(IR1_{α°}+. . . +IR1_{β°}) ∥ and ∥ω₂*(IR2_{α}+. . . +IR2_{β°}) ∥ corresponding to the first speaker and the second speaker in the direction range of α°-β°, respectively, form another constraint function group ∥ω₁*(IR1_{α°}+. . . +IR1_{β°})+ω₂*(IR2_{α°}+ . . . +IR2_{β°}) ∥ (also referred to as “second constraint function”). The second constraint function may indicate an average sound pressure level of the acoustic output device in the direction range α°-β°. When minimizing the second constraint function, the two filter functions ω₁ and ω₂ that minimize the average sound pressure of the acoustic output device in the range of α°-β° may be obtained.

In some embodiments, after obtaining the first filter function ω₁ and the second filter function ω₂ based on the second constraint function, the first filter is made to filter the first electrical signal based on the first filter function ω₁, the second filter is made to filter the second electrical signal based on the second filter function ω₂, and the first electrical signal and the second electrical signal generated by the processing respectively excite the first speaker and the second speaker, to realize the directivity of the acoustic output device in the α°-β° direction range, i.e., to minimize the average sound pressure in the direction range of α°-β°. For example, to realize the directivity of the acoustic output device in the direction range of 135°-225°, the second constraint function is constructed as ∥ω₁*(IR1₁₃₅°+ . . . +) IR1_{225°}+ω₂*(IR2₁₃₅°+ . . . +) IR2₂₂₅° ∥, and the second constraint function is minimized to obtain the corresponding first filter function ω₁ and the corresponding second filter function ω₂. The first electrical signal and the second electrical signal modulated based on the first filter function ω₁ and the second filter function ω₂ are used to excite the first speaker and the second speaker, respectively, so that the directivity of the acoustic output device in the direction range of 135°-225° is realized.

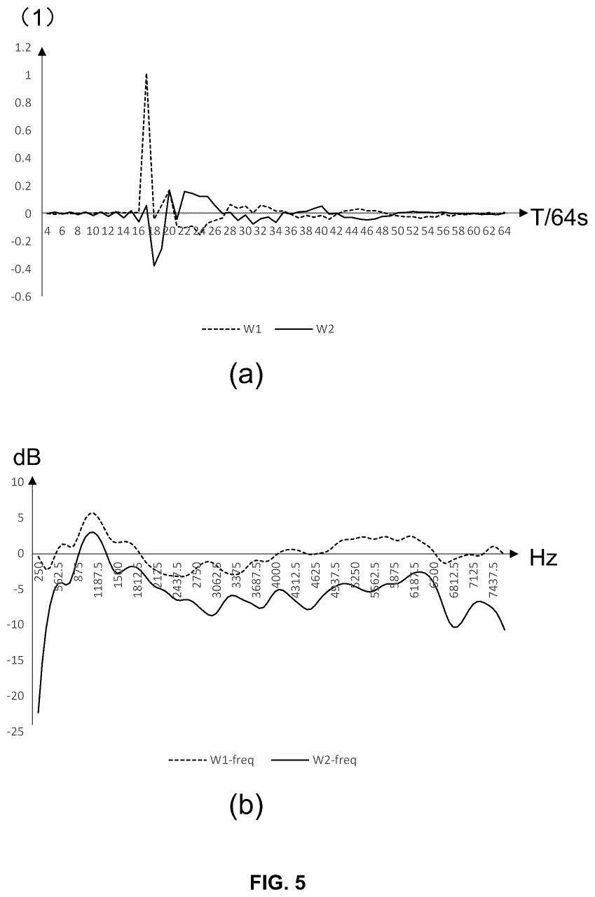

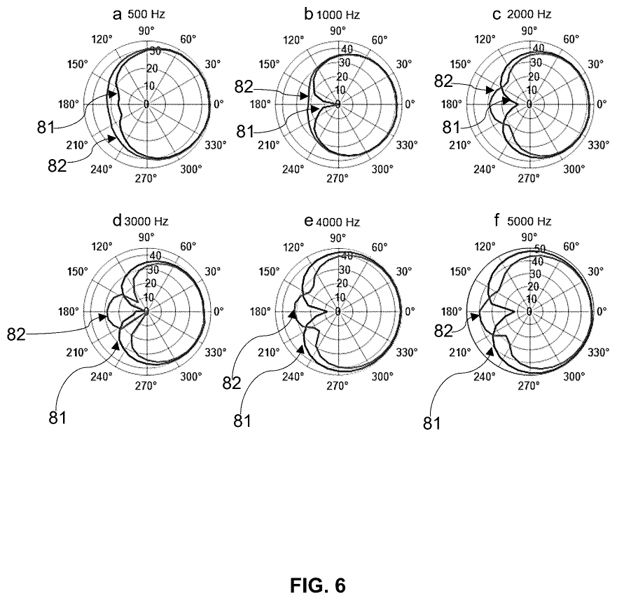

FIG. 5 is a graph illustrating a time domain and a frequency domain of filter functions ω₁ and ω₂ according to some embodiments of the present disclosure. In some embodiments, a first filter function ω₁ and a second filter function ω₂ are obtained based on the minimum value of the first constraint function ∥ω₁*IR1_{180°}+ω₂*IR2_{180°}∥, as shown in (a) of FIG. 5. A horizontal axis of (a) in FIG. 5 represents a period (T/64s), a vertical axis represents a normalized amplitude (1), and T represents a time of one cycle of the sampled signal. The first electrical signal and the second electrical signal processed by the first filter function ω₁ and the second filter function ω₂ respectively excite a first speaker and a second speaker. A sound pressure level of the acoustic output device obtained from the test is shown in (b) of FIG. 5. The horizontal coordinate of (b) in FIG. 5 represents the frequency in Hz, and the vertical coordinate represents the sound pressure level in dB. FIG. 6 is a schematic diagram illustrating a sound pressure distribution obtained from testing according to some embodiments of the present disclosure. As shown in FIG. 6, a curve 81 represents the sound pressure distribution with the minimum sound pressure level in a 180° direction, and curve 82 represents the sound pressure distribution with the minimum average sound pressure level in a direction range of 135°-225°. According to the curve 81 and the curve 82, the first filter function ω₁ and the second filter function ω₂ obtained based on the first constraint function can make the acoustic output device achieve a directivity in a specific direction, e.g., the minimum sound pressure level in the 180° direction and the maximum sound pressure level in the 0° direction. The first filter function ω₁ and the second filter function ω₂ obtained based on the second constraint function can make the acoustic output device achieve the minimum average sound pressure level in different directions in the direction range of 135°-225°. This means that the ω₁ and ω₂ obtained based on the first constraint function can make the acoustic output device have a relatively strong sound leakage reduction effect in the 180° direction, but the range of the sound leakage reduction is relatively narrow. For the ω₁ and ω₂ obtained based on the second constraint function, although the sound leakage reduction effect of the acoustic output device in the specific direction is weakened, the direction range for sound leakage reduction is extended. In other words, the first constraint function and the second constraint function may satisfy the requirements of different user application scenarios, and improve the sound leakage reduction effect according to different environments. a, b, c, d, e, and f in FIG. 6 represent the sound pressure distributions under the excitation signals of 500 Hz, 1000 Hz, 2000 Hz, 3000 Hz, 4000 Hz and 5000 Hz, respectively. According to a, b, c, d, e, and f in FIG. 6, by constructing the constraint function, the acoustic output device may present an expected sound pressure distribution at different frequencies.

In some embodiments, a processing circuit provides a plurality of constraint function groups, and different constraint function groups provide the acoustic output device with different sound pressure distributions. For example, different constraint function groups at the same frequency make the minimum far-field sound pressure level of the acoustic output device correspond to different directions. The different directions corresponding to the minimum far-field sound pressure level refer to a directivity direction of the acoustic output device or a direction range corresponding to directivity within a specific direction range (hereinafter referred to as a directivity direction range). That is, the directivity direction or the directivity direction range of the acoustic output device may be adjusted based on the different constraint function groups at the same frequency. To achieve this purpose, different first constraint functions or second constraint functions corresponding to different directions may be determined, and the first constraint functions or the second constraint functions may be minimized to obtain different groups of first filter functions and second filter functions. Based on a modulation on an electrical signal by the first filter function and the second filter function, the directivity direction or the directivity direction range of the acoustic output device may be adjusted at the same frequency. In some embodiments, due to the different wearing angles of the acoustic output device, a sound leakage reduction direction of the acoustic output device needs to be adjusted accordingly, and at this time, the directivity direction of the acoustic output device may be adjusted at the same frequency based on the constraint function to adjust the direction corresponding to the minimum far-field sound pressure level of the acoustic output device to a direction opposite to the user's ear. In some embodiments, the acoustic output device needs to adjust different sound leakage reduction ranges for different user application scenarios, for example, in relatively quiet use scenarios such as in a library, an office, etc., the filter function is selected according to the different needs of the sound leakage reduction direction, and the direction corresponding to the minimum far-field sound pressure level of the acoustic output device is adjusted to the direction of other people around the acoustic output device, for example, the direction range with an angle of 30 degrees, 40 degrees, 50 degrees, etc. from the sagittal axis of the user, so as to prevent sound leakage from disturbing others. As another example, the direction corresponding to the minimum far-field sound pressure level of the acoustic output device is adjusted based on the filter function, according to different sound leakage reduction requirements corresponding to a use period of the acoustic output device.

In some embodiments, the acoustic output device exhibits different sound pressure distributions at different frequencies. At this time, the processing circuit provides the speaker with different constraint function groups at two different frequencies in the target frequency range. In some embodiments, the directivity direction or the directivity direction range of the acoustic output device is adjusted at two different frequencies based on different constraint function groups. To this end, different first constraint functions or second constraint functions corresponding to the different directions may be determined, and the first constraint function or the second constraint function may be minimized to obtain different groups of first filter functions and second filter functions. The first electrical signal and the second electrical signal may be modulated based on the first filter function and the second filter function, respectively, such that the directivity direction or the directivity direction range of the acoustic output device may be adjusted at different frequencies. For example, according to different requirements for the sound leakage reduction effects corresponding to different frequency ranges, the direction corresponding to the minimum far-field sound pressure level of the acoustic output device is adjusted based on the filter function. Specifically, in an audible frequency range where the human ear is more sensitive, for example, 2000 Hz-4000 Hz, the minimum far-field sound pressure level of the acoustic output device may be adjusted to point to the opposite direction of the direction in which the user's ear is located, and in a relatively insensitive listening band for the human ear, e.g., 200 Hz-400 Hz, the minimum far-field sound pressure level of the acoustic output device may be adjusted to other directions.

In some embodiments, the constraint function may be determined based on user input. The processing circuit may adjust the constraint function in real time based on the user input. In some embodiments, information input by the user is different, the processing circuit constructs different constraint functions, and the obtained filter functions after minimizing the constraint functions are different. In some embodiments, the user may input instructions for the processing circuit to adjust the constraint function and the filter function based on his or her own needs via the user input module to adjust the sound pressure distribution of the acoustic output device. In some embodiments, the user input includes a command input, a voice input, etc. The command input may be realized based on touching, pressing, etc. For example, the user inputs the command by touching for a duration greater than a time threshold. As another example, the user activates a voice input mode of the acoustic output device by touching or other manners, and then verbally inputs the command.

Merely by way of example, the user selects the mode according to the environment (i.e., the application environment of the acoustic output device) where he or she is located, and the mode includes a noisy environment, a quiet environment, etc., or a first-level environment, a second-level environment, a third-level environment, etc., where the first level, the second level, and the third level indicate the sound pressure level of the environment. The user may also directly input information of the application scene, such as a scene name (handling official business, outdoor, reading, etc.), the sound pressure level of the environment, etc. The processing circuit, in response to the mode selection or the input information of the user, may obtain a new filter function and use the new filter function to modulate the corresponding electrical signal, thereby realizing the adjustment of the sound pressure distribution. For example, if the user is in a quiet environment or inputs the information about the application scenario of “work”, the processing circuit adopts the first constraint function to minimize the sound pressure of the acoustic output device in a specific direction. As another example, for the noisy environment, the processing circuit adopts the second constraint function to allow the acoustic output device to have a relatively small sound pressure in a specific direction range.

In some embodiments, the constraint function is obtained by responding to signals detected by sensors on the acoustic output device, and the processing circuit adjusts the direction corresponding to the constraint function based on a detection result. For example, if it is known based on the detection results that the surrounding human voices mainly originate from the 180° direction of the acoustic output device, the constraint function is constructed to reduce the far-field sound pressure level of the acoustic output device in the 180° direction. In some embodiments, the constraint function adjusted by the processing circuit is different for different detection results, and the filter function obtained after minimizing the constraint function is different. In some embodiments, the acoustic output device automatically identifies the environment where the user is located, obtains the detection result, and the processing circuit adjusts the filter function based on the detection result to adjust the sound pressure distribution of the acoustic output device.

Merely by way of example, the acoustic output device utilizes a sensor to identify the environment where the acoustic output device is located (e.g., the sound pressure level of the environment), uses the information obtained from the sensor identification as the detection result, and the processing circuit obtains a new filter function in response to the detection result, and uses the new filter function to modulate the corresponding electrical signal, thereby realizing the adjustment of the sound pressure distribution. In some embodiments, when the application environment where the acoustic output device is located changes, the sensor identifies the change in the application environment and further identifies new information in the new application environment to update the detection result, and the processing circuit adjusts the filter function in response to the updated detection result, and uses the new filter function to modulate the corresponding electrical signal, thereby realizing the adjustment of the sound pressure distribution.

In some embodiments of the present disclosure, different filter function groups are determined based on different constraint function groups, and the electrical signals are filtered to generate the first electrical signal and the second electrical signal, respectively, so that the acoustic output device presents different sound pressure distributions to satisfy the requirements of different use scenarios of the acoustic output device. Exemplary descriptions of possible sound pressure distributions of the acoustic output device are provided below. It is appreciated that by setting the filter function, the acoustic output device may exhibit at least one of the different sound pressure distributions described below. Additionally, by adjusting the filter function, the acoustic output device may be switched between a plurality of sound pressure distributions as described below to satisfy the requirements of different scenarios. Of course, the following descriptions of the sound pressure distributions are provided as examples only, and do not constitute a limitation of other possible ways of the sound pressure distribution.

In some embodiments, in conjunction with the curve 81 shown in FIG. 6, the acoustic output device has a first sound pressure level in the far field in a first direction (0° direction shown in FIG. 6), and the acoustic output device has a second sound pressure level in the far field in a second direction (180° direction shown in FIG. 6). In some embodiments, the first direction and the second direction are related to positions of the dual or multiple sound sources, i.e., the positions of the holes on the acoustic output device, and more relevant descriptions can be found in the FIGS. 7-11 and their related descriptions. The filter function is obtained by minimizing the first constraint function ∥ω₁*IR1_{180°}+ω₂*IR2₁₈₀°∥associated with the far-field sound pressure in the second direction. By filtering the electrical signal based on the obtained filter function, the second sound pressure level in the 180° direction of the acoustic output device may be the minimum sound pressure level in the far field. The first direction is near the ear canal opening of the user, and the second direction is far from the ear canal opening of the user. When the first sound pressure level is relatively great, the user receives a relatively great sound volume, and the listening effect of the user may be improved. When the second sound pressure level is relatively small, the sound leakage volume of the acoustic output device is relatively small, which improves the sound leakage reduction effect of the acoustic output device.

In some embodiments, a difference between the first sound pressure level and the second sound pressure level is used to reflect the strength of the sound leakage reduction effect of the acoustic output device. In some embodiments, the direction range near the second direction also has a moderate amount of sound leakage reduction effect, so that the sound leakage reduction range of the acoustic output device is equivalently considered to be a range within a sector region with an angle less than 30° with the second direction.

In some embodiments, the difference between the first sound pressure level and the second sound pressure level of the acoustic output device is greater than 12 dB. This makes the radiated sound of the acoustic output device transmitted to the user at the ear canal opening of the user large, with less sound leakage from the acoustic output device. In some embodiments, at a first frequency, the difference between the first sound pressure level and the second sound pressure level of the acoustic output device is greater than 12 dB, and a difference between the far-field sound pressure level in any direction with an angle less than 30° with the second direction and the second sound pressure level is not less than 6 dB. Under such a sound pressure distribution, the acoustic output device may achieve a strong sound leakage reduction effect in a specific direction, and in a relatively small direction range, a relatively good sound leakage reduction effect is achieved. It is appreciated that this sound pressure distribution corresponds to the minimum sound pressure level of the acoustic output device in a specific direction as described above. In some embodiments, to further improve the sound leakage reduction effect of the acoustic output device, at the first frequency, the difference between the first sound pressure level and the second sound pressure level of the acoustic output device is greater than 18 dB, and a difference between the far-field sound pressure level in any direction with an angle less than 30° with the second direction and the second sound pressure level is not less than 6 dB. In some embodiments, to further improve the sound leakage reduction effect of the acoustic output device, at the first frequency, the difference between the first sound pressure level and the second sound pressure level of the acoustic output device is greater than 12 dB, and a difference between the far-field sound pressure level in any direction with an angle less than 25° with the second direction and the second sound pressure level is not less than 6 dB. In some embodiments, to further improve the sound leakage reduction effect of the acoustic output device, at the same frequency, the difference between the first sound pressure level and the second sound pressure level of the acoustic output device is greater than 12 dB, and a difference between the far field sound pressure level in any direction with an angle less than 30° with the second direction and the second sound pressure level is not less than 8 dB. In some embodiments, the first frequency is in a range of 1000 Hz-8000 Hz.

The sound pressure distribution that achieves a relatively strong sound leakage reduction effect in a relatively small direction range provided in some embodiments of the present disclosure may be applied to scenarios that require a significantly improved sound leakage reduction over a relatively small direction range. For example, the sound pressure distribution is applied to a relatively fixed scenario such as taking public transportation, in a library, and in an office, where the sound leakage reduction is intensely improved in a certain direction range to a side of the user, so as to avoid the sound leakage from the acoustic output device interfering with people in the specific direction range to the side of the user and improve the privacy of listening or talking.

In some embodiments, in conjunction with the curve 82 shown in FIG. 6, the acoustic output device has the first sound pressure level in the far field in the first direction, and the acoustic output device has the second sound pressure level in the far field in the second direction. At this time, the filter function is obtained by minimizing the constraint function ∥ω₁*(IR1₁₃₅°+ . . . +) IR1_{225°}+ω₂*(IR2₁₃₅°+ . . . +) IR2₂₂₅° ∥associated with the far-field sound pressure in a direction range with an angle less than 45° from the 180° direction. The electrical signals is filtered based on the obtained filter function such that the acoustic output device has a relatively low sound pressure level in the direction range of 135°-225°, thereby improving the sound leakage reduction effect. In some embodiments, the direction range near 135° direction and near 225° direction are also capable of achieving a moderate amount of sound leakage reduction. At this point, the sound leakage reduction range of the acoustic output device is equivalently regarded as a direction range of a sector region formed at an angle greater than 45° with the second direction.

In some embodiments, a difference between the first sound pressure level and the second sound pressure level of the acoustic output device is greater than 9 dB, such that the sound radiated by the acoustic output device and transmitted to the ear canal opening of the user is relatively loud, and the sound leakage of the acoustic output device is relatively small. In some embodiments, at the second frequency, the difference between the first sound pressure level and the second sound pressure level of the acoustic output device is greater than 9 dB, and the direction having a far-field sound pressure level 6 dB greater than the second sound pressure level forms an angle greater than 45° with the second direction. That is, the sound pressure level in the direction range with an angle less than 45° with the second direction may be 6 dB greater than the second sound pressure level. With this sound pressure distribution, the acoustic output device may achieve a better sound leakage reduction effect in a relatively great direction range. It is appreciated that the sound pressure distribution corresponds to the acoustic output device with a relatively small average sound pressure level over a specific direction range as described above. The filter function is obtained by minimizing the constraint function within the direction range with an angle less than 45° with the second direction. In some embodiments, to further improve the sound leakage reduction effect of the acoustic output device, at the second frequency, the difference between the first sound pressure level and the second sound pressure level of the acoustic output device is greater than 12 dB, and the direction having a far-field sound pressure level 6 dB greater than the second sound pressure level forms an angle greater than 50° with the second direction. In some embodiments, to further improve the sound leakage reduction effect of the acoustic output device, at the second frequency, the difference between the first sound pressure level and the second sound pressure level of the acoustic output device is greater than 15 dB, and the direction having a far-field sound pressure level 6 dB greater than the second sound pressure level forms an angle greater than 45° with the second direction. In some embodiments, to further improve the sound leakage reduction effect of the acoustic output device, at the second frequency, the difference between the first sound pressure level and the second sound pressure level of the acoustic output device is greater than 12 dB, and the direction having a far-field sound pressure level 8 dB greater than the second sound pressure level forms an angle greater than 45° with the second direction. In some embodiments, the second frequency may be in a range of 200 Hz-1000 Hz.

The sound pressure distribution that achieves a relatively strong sound leakage reduction effect over a relatively great direction range provided by some embodiments of the present disclosure may be applied to scenarios where the sound leakage reduction needs to be improved over a great range of direction angles. For example, the sound pressure distribution is applied when a crowd around the user is widely and irregularly distributed or in scenarios where the crowd around the user is far away (e.g., sports scenarios, street scenarios, etc.). In such scenarios, there is no need to ensure that the acoustic output device has an optimal sound leakage reduction effect in a specific direction, but allows the acoustic output device to achieve a certain amount of sound leakage reduction over a great direction range.

In some embodiments, when the acoustic output device presents a sound field distribution with a minimum far-field sound pressure level in a specific direction, the directions of the minimum far-field sound pressure levels of the acoustic output device are different at two different frequencies within the target frequency range. In some embodiments, the direction corresponding to the minimum far-field sound pressure level of the acoustic output device at different frequencies can be adjusted using the first constraint function corresponding to the different directions. For example, by constructing different first constraint functions, at a specific frequency, the far-field sound pressure level of the acoustic output device is minimized in the direction of 180°; and at another frequency, the far-field sound pressure level of the acoustic output device is minimized in a direction that is different from the direction of 180°.

The directivity of the acoustic output device provided by some embodiments of the present disclosure at two different frequencies within the target frequency range, or the direction of sound leakage, may be applied to a selection of the directivity at different frequencies. Merely by way of example, in a frequency band where the human ear is more sensitive (e.g., 2000 Hz-4000 Hz), the direction corresponding to the minimum far-field sound pressure level of the acoustic output device is in the 180° direction, with an emphasis on the reduction of sound leakage to the side of the acoustic output device. The direction corresponding to the minimum far-field sound pressure level of the acoustic output device in a frequency band (e.g., 5000 Hz-8000 Hz) to which the human ear is not sensitive may be a direction other than the 180° direction, e.g., the 160° direction, the 200° direction, etc.

In some embodiments, when the acoustic output device is actually worn, due to different wearing angles or other reasons, the direction in which the sound leakage reduction is required changes, and the direction of the sound leakage reduction of the acoustic output device should be adjusted to the direction where the sound leakage reduction is actually required, i.e., a fourth direction. An opposite direction of the fourth direction is a third direction. Based on the constraint function, the directivity direction of the acoustic output device may be adjusted, so that the direction corresponding to the minimum far-field sound pressure level of the acoustic output device is adjusted to the fourth direction. The filter function at this point may be obtained by minimizing the constraint function.

In some embodiments, at a third frequency, an angle formed by the fourth direction and the second direction is greater than 15°, and a difference between the second sound pressure level of the acoustic output device in the second direction and the minimum far-field sound pressure level is greater than 6 dB. The sound leakage reduction effect may be ensured in a direction range that deviates from the second direction by a relatively great angle. In some embodiments, at the third frequency, the angle formed by the fourth direction and the second direction is greater than 25°, and the difference between the first sound pressure level and the second sound pressure level of the acoustic output device is greater than 6 dB. In some embodiments, the angle formed by the fourth direction and the second direction is adjusted according to a required direction range for the sound leakage reduction, for example, the angle formed by the fourth direction and the second direction is adjusted to be greater than 45° according to a direction range required for the sound leakage reduction. In some embodiments, the third frequency is in a range of 200 Hz-8000 Hz.

Some embodiments of the present disclosure provide a sound pressure distribution that ensures the sound leakage reduction effect over a direction range that deviates from the second direction by a large angle. The sound pressure distribution is applied to a scenario where the sound leakage reduction effect is improved in a wide direction range away from the side of the acoustic output device. For example, this sound pressure distribution is applied to scenarios where the sound leakage reduction effect is improved within a range of a front or rear side when a specific person is located at the front or rear side of the user, so as to avoid the sound leakage output by the acoustic output device from causing interference to the person at the front or rear side. For example, the sound pressure distribution is applied to a situation where the side of the acoustic output device does not coincide with the side of the user due to a wearing problem, i.e., when the side of the acoustic output device points in the second direction and the side of the user points in the fourth direction, the sound leakage reduction effect in the side range of the user is improved to avoid the sound output by the acoustic output device from interfering with the people on the side of the user's. As a further example, the sound pressure distribution is applied to a scenario where the user needs to move, and when the user is moving, the direction range where the sound leakage reduction is required also changes. At this time, the sound leakage reduction effect needs to be achieved in a wider direction range to satisfy the requirement of sound leakage reduction.

The above-mentioned method adjusts the amplitudes and/or the phases of the first electrical signal and the second electrical signal by constructing the constraint function, so as to adjust the sound pressure distribution of the second speaker and the first speaker, so that the far-field radiation of the acoustic output device has the directivity, thereby reducing the sound leakage of the acoustic output device in the far field. The directivity of the acoustic output device may be flexibly adjusted by adjusting the amplitudes and/or the phases of the first electrical signal and the second electrical signal through the first filter function and the second filter function, respectively. The first speaker and the second speaker in the acoustic output device may have a variety of structures, which are exemplarily illustrated hereinafter in conjunction with FIGS. 7-12.

FIG. 7-FIG. 10 are schematic diagrams illustrating acoustic output devices with different structures according to some embodiments of the present disclosure.

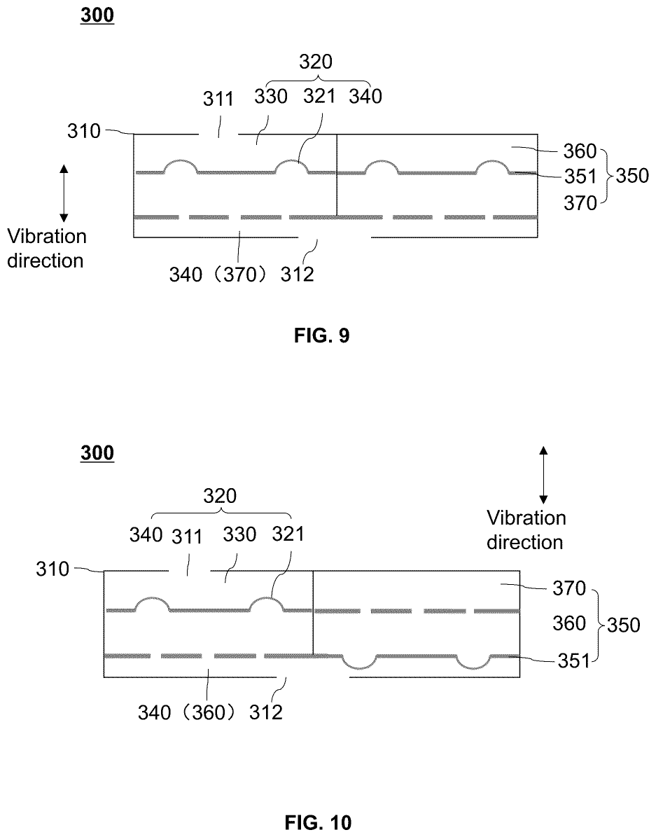

As shown in FIGS. 7-10, an acoustic output device 300 includes a housing 310, a first speaker 320, and a second speaker 350, and the first speaker 320 and the second speaker 350 are provided in the housing 310. The first speaker 320 includes a first diaphragm 321, a front side and a rear side of the first diaphragm 321 are correspondingly disposed with a first front cavity 330 and a first rear cavity 340, and the first front cavity 330 and the first rear cavity 340 are respectively coupled to a first hole 311 and a second hole 3212 disposed on the housing to respectively output a first sound wave and a second sound wave with a phase difference. The second speaker 350 includes a second diaphragm 351, and a front side and a rear side of the second diaphragm are respectively disposed with a second front cavity 360 and a second rear cavity 370, and one of the second front cavity 360 and the second rear cavity 370 is the same cavity as the first rear cavity 340. As shown in FIG. 7 and FIG. 9, the second rear cavity 370 forms the same cavity as the first rear cavity 340. As shown in FIG. 8 and FIG. 10, the second front cavity 360 forms the same cavity as the first rear cavity 340. The second front cavity 360 or the second rear cavity 370, which forms the same cavity as the first rear cavity 340, is acoustically coupled to the second hole 312 on the housing 310. The second speaker 350, driven by a second electrical signal, outputs a third sound wave through the second hole 312. It is appreciated that the third hole of the second speaker in the above example refers to the second hole 312, but in some other embodiments, the third hole of the second speaker is a hole other than the first hole 311 and the second hole 312.

Continuing to refer to FIGS. 7-10, in some embodiments, the first diaphragm 321 vibrates in the same or approximately the same direction (e.g., up and down in FIGS. 7-10) as the second diaphragm 351. In some embodiments, the first diaphragm 321 and the second diaphragm 351 are spaced apart along the vibration direction, i.e., the first speaker 320 and the second speaker 350 are spaced apart along the vibration direction (as shown in FIGS. 7-8). The first diaphragm 321 and the second diaphragm 351 can also be spaced apart in a direction perpendicular to the vibration direction, i.e., the first speaker 320 and the second speaker 350 are spaced apart along the direction perpendicular to the vibration direction (as shown in FIGS. 9-10). It should be noted that the first diaphragm 321 vibrating in approximately the same direction as the second diaphragm 351 refers to that an angle between the vibration directions of the first diaphragm 321 and the second diaphragm 351 is less than a specific value (e.g.,) 10°, etc.

In some embodiments, an orientation of the first diaphragm 321 is in the same or opposite direction as an orientation of the second diaphragm 351. In some embodiments, as shown in FIG. 7, the orientation of the first diaphragm 321 is opposite to the orientation of the second diaphragm 351, the first diaphragm 321 is spaced apart from the second diaphragm 351 along the vibration direction, the first rear cavity 340 is in communication with the second rear cavity 370 to form the same cavity, and the second front cavity 360 remains closed. In some embodiments, as shown in FIG. 8, the orientation of the first diaphragm 321 is in the same as the orientation of the second diaphragm 351, the first diaphragm 321 and the second diaphragm 351 are spaced apart along the vibration direction, the first rear cavity 340 is in communication with the second front cavity 360 to form the same cavity, and the second rear cavity 370 remains closed. In some embodiments, as shown in FIG. 9, the orientation of the first diaphragm 321 is the same as the orientation of the second diaphragm 351, the first diaphragm 321 and the second diaphragm 351 are spaced apart along the direction perpendicular to the vibration direction, the first rear cavity 340 is in communication with the second front cavity 360 to form the same cavity, and the second rear cavity 370 remains closed. In some embodiments, as shown in FIG. 10, the orientation of the first diaphragm 321 is opposite to the orientation of the second diaphragm 351, the first diaphragm 321 and the second diaphragm 351 are spaced apart in the direction perpendicular to the vibration direction, the first rear cavity 340 is in communication with the second rear cavity 370 to form the same cavity, and the second front cavity 360 remains closed.

A far-field radiated sound of the acoustic output device 300 shown in FIGS. 7-10 exhibits a directivity. When the user wears the acoustic output device 300, the direction from the second hole 312 to the first hole 311 points to the ear canal opening of the user, i.e., the direction from the second hole 312 to the first hole 311 is the 0° direction as shown in FIG. 6, which is the first direction. The direction fromthe first hole 311 to the second hole 312 is away from the ear canal opening of the user, i.e., the direction from the first hole 311 to the second hole 312 is the 180° direction as shown in FIG. 6, which is the second direction.

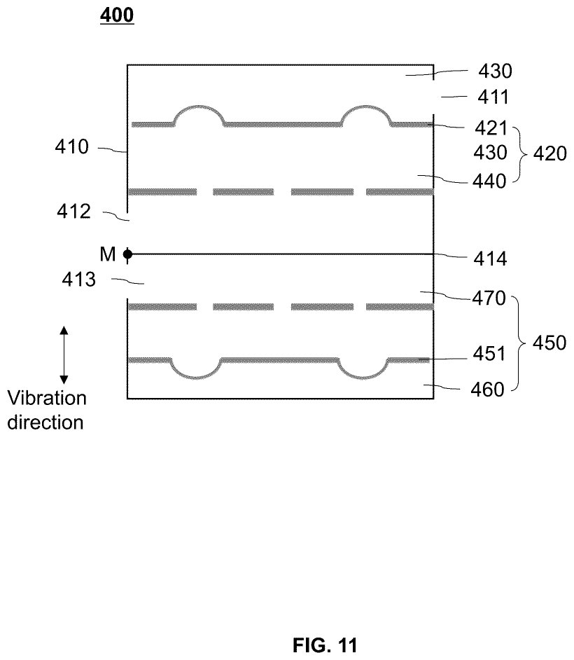

FIG. 11 is a schematic diagram illustrating a structure of an acoustic output device according to some other embodiments of the present disclosure. As shown in FIG. 11, an acoustic output device 400 includes a housing 410, a first speaker 420, and a second speaker 450. The first speaker 420 includes a first diaphragm 421, the front and rear sides of the first diaphragm are provided with a first front cavity 430 and a first rear cavity 440, respectively, and the housing 410 is provided with a first hole 411 acoustically coupled to the first front cavity 430, and a second hole 412 acoustically coupled to the first rear cavity 430. The first hole 411 and the second hole 412 serve as outlet holes of the first speaker 420 to form dual sound sources. The second speaker 450 includes a second diaphragm 451, and the front and rear sides of the second diaphragm 451 are provided with a second front cavity 460, and a second rear cavity 470, respectively. The housing 410 is provided with a third hole 413 acoustically coupled to the second rear cavity 470, the third hole 413 is a hole that is different from the first hole 411 and the second hole 412. The second front cavity 460 serves as a closed cavity. The third hole 413 serves as a sound outlet hole of the second speaker 450 to form a single sound source. It is to be understood that positions of the second front cavity 460 and the second rear cavity 470 may be exchanged, the second front cavity 460 is acoustically coupled to the third hole 413, and the second rear cavity 470 serves as a closed cavity.

In some embodiments, a spacer 414 is provided in the housing 410, the second rear cavity 470 (or the second front cavity 460) acoustically coupled to the third hole 413 is separated from the first rear cavity 440 by the spacer 414, and the second hole 412 and the third hole 413 are located on two sides of the spacer 414, respectively. The first speaker 420 and the second speaker 450 do not share the same cavity, so that the sound waves radiated by the first speaker 420 and the second speaker 450 do not interfere with each other, and a mutual radiation impedance is reduced.

Some embodiments of the present disclosure avoid the first speaker and the second speaker from sharing the same cavity by setting the cavities of the first speaker and the second speaker independently from each other, so that the sound waves radiated by the first speaker and the second speaker do not interfere with each other, and the mutual impedance is reduced.

When the third hole is a different hole from the first hole and the second hole, to determine the first direction and the second direction, it is necessary to determine an equivalent hole formed by the third hole, the first hole, and the second hole. A position of the equivalent hole may be determined by: sequentially connecting center points of adjacent holes to form a line segment, a polygon, or a polyhedron, and taking a midpoint of the line segment, a center of the polygon, or a center of the polyhedron as a center point of the equivalent hole. The center point of the equivalent hole may be used to indicate the position of the equivalent hole. As shown in FIG. 11, the second hole 412 and the third hole 413 are adjacent to each other, and the line segment is formed by connecting the center of the second hole 412 to the center of the third hole 413, and a midpoint M of the line segment is considered to be a position of an equivalent hole of the second hole 412 and the third hole 413.

A far-field radiated sound of the acoustic output device 400 shown in FIG. 11 exhibits a directivity. When the user wears the acoustic output device 400, the direction from the above-described equivalent hole to the first hole 411 points to the ear canal opening of the user, i.e., the direction from the equivalent hole to the first hole 411 is the 0° direction as shown in FIG. 6, i.e., the first direction. The direction from the first hole 411 to the equivalent hole is away from the ear canal opening of the user, that is, the direction from the first hole 411 to the equivalent hole is the 180° direction as shown in FIG. 6, that is, the second direction.

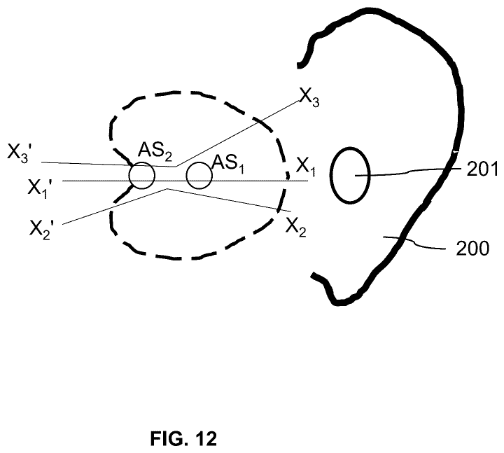

FIG. 12 is a schematic diagram illustrating a directivity according to some embodiments of the present disclosure. Referring to FIG. 12, the acoustic output device shown in FIG. 12 is in a wearing state. AS₁ denotes a first hole of the acoustic output device, and AS₂ denotes a second hole of the acoustic output device. In some embodiments, a far-field radiation of the acoustic output device having a directivity refers to that a sound output direction of the acoustic output device is located within a specific direction range, i.e., a far-field radiation of the acoustic output device in the specific direction range is significantly greater or less than a far-field radiation outside the specific direction range. For example, the acoustic output device has the directivity (the first direction is co-linear with the second direction) in either the first direction or the second direction described above.

In some embodiments, in the wearing state, a direction X₁ and directions near X₁ (e.g., directions X₂ and X₃) from the second hole AS₂ for sound emission (the second hole AS₂ corresponds to the rear cavity of the acoustic output device) to the first hole AS₁ for sound emission (the first hole AS₁ corresponds to the front cavity), points to the user's ear canal opening 201. A direction X₁′ and directions near X₁′ (e.g., a direction X₂′ and a direction X₃′) from the first hole AS₁ to the second hole AS₂ are away from the ear canal opening 201 of the user. The direction X₁ is the first direction and the direction X₁′ is the second direction. In some embodiments, a direction near X₁′ is understood as a direction or direction range whose angle with direction X₁′ is less than a preset angle. The preset angles may be 10°, 15°, 25°, 30°, 35°, etc. In some embodiments, the far-field radiation of the acoustic output device in the first direction is significantly greater than the far-field radiation in other direction ranges (e.g., a direction perpendicular to the first direction, a direction opposite to the first direction, etc.).

In some embodiments, the directivity of the acoustic output device is manifested in such a way that an absolute value of the difference between a sound pressure level at a far field position in a specific direction of the acoustic output device and a sound pressure level at a far field position in an opposite direction is not less than a preset sound pressure level difference threshold. In the wearing state, the specific direction may be a direction in which the acoustic output device is away from the ear canal opening of the user, and the opposite direction thereof may be a direction from the acoustic output device to the ear canal of the user. In some embodiments, the preset sound pressure level difference threshold may be 6 dB, 8 dB, 10 dB, 12 dB, 16 dB, 18 dB, etc. It is to be understood that, for the purpose of facilitating the understanding of directivity, only two holes, AS₁ and AS₂, are exemplarily illustrated herein. When there are more different holes in the acoustic output device, AS₁ may be understood as an equivalent hole formed by some of the holes, and AS₂ may be understood as an equivalent hole formed by the other holes, at which point a direction of the directivity may be determined by positions of the equivalent holes. In some embodiments, the position of the equivalent hole formed by a plurality of holes is determined by sequentially connecting the centers of the adjacent holes to form a polygon, and a center of the polygon is the center of the equivalent hole, which is used to indicate the position of the equivalent hole.

In some embodiments, the far-field radiation of the acoustic output device exhibit a cardioid directivity similar to the curve 81 in FIG. 6, manifested by a fact that, an absolute value of the difference between the sound pressure levels of the far-field radiated sound of the acoustic output device in at least one pair of opposite directions (e.g., the first direction and the second direction) is not less than the preset sound pressure level difference threshold. The at least one pair of opposite directions may fall within a direction range of the specific direction and the opposite direction of the specific direction, respectively. In some embodiments, the at least one pair of opposite directions includes a pair of opposite directions corresponding to a line connecting the first hole AS₁ and the second hole AS₂. The cardioid directivity of the acoustic output device may be manifested as a significant difference in the acoustic field intensities of a pair of opposite or approximately opposite directions within the above-described specific direction and the opposite direction thereof. For example, the pair of opposite or approximately opposite directions refers to a direction being near the direction X₁′ from the first hole to the second hole, and the other direction being near the direction X₁ from the second hole to the first hole. For example, the direction X₁′ is opposite or approximately opposite to the direction X₁, the direction X₂, the direction X₃.

Through the cardioid directivity setting of the far-field radiation of the acoustic output device, the sound output from the acoustic output device is more centrally transmitted toward the direction of the ear canal opening of the user, which reduces the transmission of the sound in the other directions, reduces the sound leakage of the acoustic output device, and improves a listening effect of the user.

The basic concepts have been described above, and it is apparent to those skilled in the art that the above detailed disclosure serves only as an example and does not constitute a limitation of the present disclosure. Although not explicitly stated here, those skilled in the art may make various modifications, improvements, and amendments to the present disclosure. These modifications, improvements, and amendments are intended to be suggested by the present disclosure, and are within the spirit and scope of the exemplary embodiments of the present disclosure.

Moreover, certain terminology has been used to describe embodiments of the present disclosure. For example, “one embodiment,” “an embodiment,” and/or “some embodiments” means a feature, structure, or characteristic associated with at least one embodiment of the present disclosure. Accordingly, it should be emphasized and noted that two or more references to “one embodiment,” “an embodiment,” or “an alternative embodiment” in different positions in the present disclosure are not intended to be used in the present disclosure. In addition, some features, structures, or features in the present disclosure of one or more embodiments may be appropriately combined.

In addition, it is appreciated by those skilled in the art that aspects of the present disclosure may be illustrated and described by a number of patentable varieties or situations, including any new and useful process, machine, product, or combination of substances or any new and useful improvement thereof. Accordingly, all aspects of the present disclosure may be performed entirely by hardware, entirely by software (including firmware, resident software, microcode, etc.), or by a combination of hardware and software. The above hardware or software may be referred to as “data block,” “module,” “engine,” “unit,” “component,” or “system.” In addition, aspects of the present disclosure may appear as a computer product located in one or more computer-readable media, the product including computer-readable program code.

The computer storage medium may include a propagated data signal with a computer program encoded within, such as on a baseband or as a portion of a carrier. The propagation signal may have a variety of manifestations, including an electromagnetic form, an optical form, etc., or suitable combinations thereof. The computer storage medium may be any computer-readable medium other than a computer-readable storage medium, which is used by connecting to an instruction-executing system, device, or apparatus for communicating, propagating, or transmitting for use. The program code located on the computer storage medium may be propagated through any suitable medium, including radio, cable, fiber optic cable, RF, etc., or any combination of the foregoing.

In addition, unless expressly stated in the claims, the order of the processing elements and sequences, the use of numerical letters, or the use of other names as described in the present disclosure are not intended to qualify the order of the processes and methods of the present disclosure. Although the above disclosure discusses through various examples what is currently considered to be a variety of useful embodiments of the disclosure, it is to be understood that such detail is solely for illustrating purpose, and that the appended claims are not limited to the disclosed embodiments, but, on the contrary, are intended to cover modifications and equivalent arrangements that are within the spirit and scope of the disclosed embodiments. For example, while the above-described system components is implemented by hardware devices, it is also possible that they are implemented by software-only solutions, such as installing the described system on an existing processing device or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

Numbers describing the number of components, attributes, and properties are used in some embodiments, and it is to be understood that such numbers used in the description of embodiments are modified in some examples by the modifiers “about”, “approximately”, or “substantially.” Unless otherwise noted, the terms “about,” “approximately,” or “substantially” indicates that a ±20% variation in the stated number is allowed. Correspondingly, in some embodiments, the numerical parameters used in the present disclosure and the claims are approximations, which change depending on the desired characteristics of individual embodiments. In some embodiments, the numerical parameters should take into account the specified number of valid digits and use a general digit retention method. While the numerical domains and parameters used to confirm the breadth of their ranges in some embodiments of the present disclosure are approximations, in specific embodiments such values are set to be as precise as possible within a feasible range.

For each of the patents, patent applications, patent application disclosures, and other materials cited in the present disclosure, such as articles, books, specifications, publications, documents, etc., the entire contents of which are hereby incorporated herein by reference. Except for application history documents that are inconsistent with or conflict with the contents of the present disclosure, and except for documents (currently or hereafter appended to the present disclosure) that limit the broadest scope of the claims of the present disclosure. It should be noted that to the extent that there is an inconsistency or conflict between the descriptions, definitions, and/or use of terminology in the materials appurtenant to the present disclosure and those set forth herein, the descriptions, definitions, and/or use of terms in the present disclosure shall prevail.

At last, it should be understood that the embodiments described in the present disclosure are merely illustrative of the principles of the embodiments of the present disclosure. Other modifications may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An acoustic output device, comprising:
a housing;
a first speaker disposed in the housing, wherein the first speaker includes a first diaphragm, in the housing, a front side and a rear side of the first diaphragm are respectively disposed with a first front cavity and a first rear cavity, and the first front cavity and the first rear cavity are acoustically coupled to two holes disposed on the housing, respectively, to output a first sound wave and a second sound wave with a phase difference;
a second speaker disposed in the housing, wherein the second speaker includes a second diaphragm, in the housing, a front side and a rear side of the second diaphragm are respectively disposed with a second front cavity and a second rear cavity, and only one of the second front cavity and the second rear cavity is acoustically coupled to a hole disposed on the housing to output a third sound wave; and
a processing circuit, configured to provide a first electrical signal to the first speaker and provide a second electrical signal to the second speaker, wherein in a target frequency range, there is an amplitude difference and/or a phase difference between the first electrical signal and the second electrical signal to make a far-field radiated sound of the acoustic output device exhibit at least one directional sound pressure distribution.

2. The acoustic output device of claim 1, wherein the target frequency range includes 200 Hz-8000 Hz.

3. The acoustic output device of claim 2, wherein
the first front cavity and the first rear cavity are respectively coupled to a first hole and a second hole disposed on the housing,
one of the second front cavity and the second rear cavity is the same cavity as the first rear cavity, and the second front cavity or the second rear cavity that forms the same cavity with the first rear cavity outputs the third sound wave through the second hole, and
a direction from the second hole to the first hole is a first direction, and a direction from the first hole to the second hole is a second direction, or
one of the second front cavity and the second rear cavity is coupled to a third hole on the housing, the third hole is a hole different from the first hole and the second hole, and
the second hole and the third hole form an equivalent hole, a direction form the equivalent hole to the first hole is a first direction, and a direction from the first hole to the equivalent hole is a second direction.

4. (canceled)

5. The acoustic output device of claim 3, wherein the at least one directional sound pressure distribution includes:
at a first frequency, a difference between a far-field sound pressure level of the acoustic output device along the first direction and a far-field sound pressure level of the acoustic output device along the second direction is greater than 12 dB, and
a difference between a far-field sound pressure level along any direction that forms an angle less than 30° with the second direction and the far-field sound pressure level along the second direction is not less than 6 dB.

6. The acoustic output device of claim 3, wherein the at least one directional sound pressure distribution includes:
at a second frequency, a difference between a far-field sound pressure level of the acoustic output device along the first direction and a far-field sound pressure level of the acoustic output device along the second direction is greater than 9 dB, and
a direction having a far-field sound pressure level 6 dB greater than the far-field sound pressure level along the second direction forms an angle greater than 45° with the second direction.

7. The acoustic output device of claim 3, wherein the at least one directional sound pressure distribution includes:
at a third frequency, a direction corresponding to a minimum far-field sound pressure level of the acoustic output device forms an angle greater than 15° with the second direction, and
a difference between a far-field sound pressure level along the second direction and the minimum far-field sound pressure level is greater than 6 dB.

8. The acoustic output device of claim 3, wherein the at least one directional sound pressure distribution includes:
minimum far-field sound pressure levels in sound pressure distributions corresponding to two different frequencies in the target frequency range correspond to different directions.

9. The acoustic output device of claim 3, wherein
the processing circuit is capable of obtaining a plurality of filter function groups, each of the plurality of filter function groups includes a first filter function and a second filter function corresponding to the first electrical signal and the second electrical signal, respectively,
the first electrical signal and the second electrical signal are modulated in response to the first filter function and the second filter function, respectively, and
different filter function groups in the plurality of filter function groups provide different sound pressure distributions for the acoustic output device at the same frequency.

10. The acoustic output device of claim 9, wherein under modulation of the different filter function groups, minimum far-field sound pressure levels in the sound pressure distributions generated by the acoustic output device at the same frequency correspond to different directions.

11. The acoustic output device of claim 9, wherein the processing circuit adjusts the plurality of filter function groups in real time based on a user input.

12. An acoustic output device, comprising:
a housing;
a first speaker disposed in the housing, wherein the first speaker includes a first diaphragm, in the housing, a front side and a rear side of the first diaphragm are respectively disposed with a first front cavity and a first rear cavity, and the first front cavity and the first rear cavity are acoustically coupled to two holes disposed on the housing, respectively, to output a first sound wave and a second sound wave with a phase difference;
a second speaker disposed in the housing, wherein the second speaker includes a second diaphragm, in the housing, a front side and a rear side of the second diaphragm are respectively disposed with a second front cavity and a second rear cavity, and only one of the second front cavity and the second rear cavity is acoustically coupled to a hole disposed on the housing to output a third sound wave; and
a processing circuit, configured to provide a first electrical signal to the first speaker and provide a second electrical signal to the second speaker, wherein
the processing circuit is capable of obtaining a plurality of filter function groups, each of the plurality of filter function groups includes a first filter function and a second filter function corresponding to the first electrical signal and the second electrical signal, respectively,
the first electrical signal and the second electrical signal are modulated in response to the first filter function and the second filter function, respectively, and
different filter function groups in the plurality of filter function groups provide different sound pressure distributions for the acoustic output device at the same frequency.

13-14. (canceled)

15. The acoustic output device of claim 12, wherein in a target frequency range, there is an amplitude difference and/or a phase difference between the first electrical signal and the second electrical signal to make a far-field radiated sound of the acoustic output device exhibit at least one directional sound pressure distribution.

16. (canceled)

17. The acoustic output device of claim 15, wherein
the first front cavity and the first rear cavity are respectively coupled to a first hole and a second hole disposed on the housing,
one of the second front cavity and the second rear cavity is the same cavity as the first rear cavity, and the second front cavity or the second rear cavity forming the same cavity with the first rear cavity outputs the third sound wave through the second hole, and
a direction from the second hole to the first hole is a first direction, and a direction from the first hole to the second hole is a second direction, or
one of the second front cavity and the second rear cavity is coupled to a third hole on the housing, the third hole is a hole different from the first hole and the second hole, and
the second hole and the third hole form an equivalent hole, a direction from the equivalent hole to the first hole is a first direction, and a direction from the first hole to the equivalent hole is a second direction.

18. (canceled)

19. The acoustic output device of claim 17, wherein the at least one directional sound pressure distribution includes:
at a first frequency, a difference between a far-field sound pressure level of the acoustic output device along the first direction and a far-field sound pressure level of the acoustic output device along the second direction is greater than 12 dB, and
a difference between a far-field sound pressure level along any direction that forms an angle less than 30° with the second direction and the far-field sound pressure level along the second direction is not less than 6 dB.

20. The acoustic output device of claim 17, wherein the at least one directional sound pressure distribution includes:
at a second frequency, a difference between a far-field sound pressure level of the acoustic output device along the first direction and a far-field sound pressure level of the acoustic output device along the second direction is greater than 9 dB, and
a direction having a far-field sound pressure level 6 dB greater than the far-field sound pressure level along the second direction forms an angle greater than 45° with the second direction.

21. The acoustic output device of claim 17, wherein the at least one directional sound pressure distribution includes:
at a third frequency, a direction corresponding to a minimum far-field sound pressure level of the acoustic output device forms an angle greater than 15° with the second direction, and
a difference between a far-field sound pressure level along the second direction and the minimum far-field sound pressure level is greater than 6 dB.

22. (canceled)

23. The acoustic output device of claim 17, wherein that the different filter function groups in the plurality of filter function groups provide different sound pressure distributions for the acoustic output device at the same frequency includes: at the same frequency,
after modulation by one of the different filter function groups, the difference between a far-field sound pressure level of the acoustic output device along the first direction and a far-field sound pressure level of the acoustic output device along the second direction is greater than 12 dB, and a difference between a far-field sound pressure level along any direction that forms an angle less than 30° with the second direction and the far-field sound pressure level along the second direction is not less than 6 dB, and
after modulation by another one of the different filter function groups, the difference between the far-field sound pressure level of the acoustic output device along the first direction and the far-field sound pressure level of the acoustic output device along the second direction is greater than 9 dB, and a direction having a far-field sound pressure level 6 dB greater than the far-field sound pressure level along the second direction forms an angle greater than 45° with the second direction.

24. An acoustic output device, comprising:
a housing;
a first speaker disposed in the housing, wherein the first speaker outputs sound waves through at least one hole on the housing, and the first speaker has a first response function in a far field;
a second speaker disposed in the housing, wherein the second speaker outputs sound waves through the at least one hole on the housing, and the second speaker has a second response function in the far field; and
a processing circuit, configured to provide a first electrical signal for the first speaker and provide a second electrical signal for the second speaker, wherein
the processing circuit constructs at least one constraint function group based on the first response function and the second response function, each constraint function group in the at least one constraint function group is used to produce a first filter function corresponding to the first electrical signal and a second filter function corresponding to the second electrical signal,
the first electrical signal and the second electrical signal are modulated by the first filter function and the second filter function, respectively, and
the each constraint function group provides a specific sound pressure distribution for the acoustic output device.

25. The acoustic output device of claim 24, wherein the at least one constraint function group includes a plurality of constraint function groups, and the each constraint function group provides a specific sound pressure distribution for the acoustic output device includes:
at the same frequency, different constraint function groups in the plurality of constraint function groups provide different sound pressure distributions for the acoustic output device, and
minimum far-field sound pressure levels in the different sound pressure distributions correspond to different directions.

26. The acoustic output device of claim 24, wherein the at least one constraint function group includes a plurality of constraint function groups, and the each constraint function group provides a specific sound pressure distribution for the acoustic output device includes:
two different frequencies in a target frequency range correspond to different constraint function groups in the plurality of constraint function groups,
the different constraint function groups provide different sound pressure distributions for the acoustic output device at the two different frequencies, and
minimum far-field sound pressure levels in the different sound pressure distributions correspond to different directions.

27. (canceled)
